(19) United States
(12) Patent Application Publication
(10) Pub. No.: US 2006/0120732 A1
(43) Pub. Date: Jun. 8, 2006

(54) Apparatus and method in optical receiver for receiving burst mode signal

(75) Inventors: Jae-Myung Baek, Suwon-si (KR); Mun-Kue Park, Suwon-si (KR); Joong-Wan Park, Suwon-si (KR); Jin-Wook Kwon, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/293,547

(22) Filed: Dec. 2, 2005

(30) Foreign Application Priority Data
Dec. 3, 2004 (KR) 2004-101163

(51) Int. Cl. H04B 10/06

(52) U.S. Cl. 398/202

(57) ABSTRACT

Disclosed is an optical receiver for receiving burst mode signals. In a first embodiment, AGC voltage is applied to a continuous mode TIA having an AGC function, so that the AGC function is stopped and a gain of the TIA is fixed to a constant. In a second embodiment, a continuous mode TIA capable of adjusting an AGC time by using an external condenser is used. Accordingly, the TIA commonly used in a continuous mode is utilized in a burst mode operation, so that the construction of the optical receiver can be simplified and cost can be saved.

### CLAIM of PRIORITY

This application claims benefit of the earlier filing date of that patent application entitled “Apparatus and Method in Optical Receiver for Receiving Burst Mode Signal” filed in the Korean Intellectual Property Office on Dec. 3, 2004 and assigned Serial No. 2004-101163, the contents of which are hereby incorporated by reference.

### BACKGROUND OF THE INVENTION

1. Field of the Invention

The present invention relates to an apparatus and a method in an optical receiver for receiving burst mode signals, and more particularly to an apparatus and a method for receiving burst mode signals by means of a continuous mode TransImpedance Amplifier (TIA).

2. Description of the Related Art

Optical subscriber network technology represents next generation access technology capable of providing each subscriber with an ultra high speed broadband access service of more than 10 Mbps by means of both a laser transmission/reception method and an optical fiber cable capable of theoretically transmitting infinite data, rather than using a typical transmission medium such as a copper wire for voice communication, a coaxial cable for cable TV, and radio frequency. Further, in order to deal with mass storage information in upcoming multimedia communication environments, an optical fiber has been used as an alternative of the current copper wire subscriber line.

With the increase of information provided by ultra high speed optical communication as described above, Fiber-To-The Home (FTTH) technology is being increasingly more important.

An optical subscriber line may be constructed as a star type, a ring type and a bus type, etc. However, the most future-oriented and economic is the Passive Optical Network (PON).

The PON uses passive components instead of expensive active components to provide an optical fiber-based ultra high speed service to an enterprise, a small office home office (SOHO) or a home, by sharing Optical Network Units (ONU) that provide various services. Thus, an economic network may be constructed. An Ethernet-based PON (E-PON) is an example of such an economically constructed network.

FIG. 1 is a diagram illustrating the construction of a conventional PON. The PON includes an Optical Line Termination (OLT) 100 in a Central Office (CO), a 1×N passive optical splitter 102, and ONUs 104a to 104n in subscriber homes or facilities

An optical transmission/reception module in the PON is integrated within one package, and uses a Bi-Directional (BiDi) scheme for exchanging signals using wavelengths of 1310 nm and 1490 nm through one optical fiber. In the current E-PON system, optical transmitters in the ONUs 104a to 104n and an optical receiver in the OLT 100 need burst mode operations. However, the fact that burst mode receivers are less developed than continuous mode receivers has been a roadblock to the growth of the E-PON market.

FIG. 2 is a graph illustrating a Bit Error Rate (BER) based on the amplitude of adjacent ONU signals received in a burst mode according to the prior art. FIG. 2 shows only a bit error rate due to interference between the one ONU and an adjacent ONU (e.g., ONU 104a and the ONU 104b). FIG. 2 illustrates that the BER has a large deviation depending on the amplitude of the adjacent ONU signals in the burst mode.

Because a continuous mode receiver receives signals from one transmitter, it is designed to receive signals of constant amplitude after it has been installed. Accordingly, the continuous mode receiver does not need to operate quickly in response to changes in the amplitude of the input signals. However, in a PON system, because a receiver in an OLT receives signals of various amplitudes from multiple ONUs, it must normally respond to each signal within a short time. Since a continuous mode TIA (TransImpedance Amplifier) is typically AC coupled to a Limiting Amplifier (LA) after the TIA and has an Automatic Gain Control (AGC) function in which the gain changes based on the input signals, a continuous mode receiver has a standardization time in the order of 3 microseconds; which is a relatively long time. Because of the time introduced by the AGC function, a TIA, such as F0100408B having no AGC function in a continuous mode, manufactured by Sumitomo, Co. Ltd., has been developed.

Further, reception Integrated Circuits (ICs) for receiving burst mode signals have been developed, but have not been commercialized. U.S. Pat. No. 6,191,879 B1 discloses a method for receiving burst mode signals in which electric current input to a TIA from a Photo Diode (PD) flows to another transistor when the measured amplitude of the output signals increase so as to cause constant signals to be input to an LA amplifier, and U.S. Pat. No. 6,072,366 discloses a method in which a reference voltage is applied to an input terminal so as to adjust the gain after the signals to the input terminal have been registered.

Because an E-PON system conventionally uses a coding scheme of 8 bits or 10 bits and a measurement scheme of a 27-1 Pseudo Random Binary Sequence (PRBS), the low frequency cut-off frequency of the system increases. Therefore, in the case of AC coupling using a condenser or capacitor of a small value (e.g. several hundreds picofarads (pF)), receiver sensitivity does not deteriorate greatly (˜0.8 dB). In this case, the fact that a settling time based on an R-C charging time is 106 ns (nanoseconds) satisfies a settling time of 400 ns defined in the USA Institute of Electrical and Electronics Engineers (IEEE) 983.ah which is an E-PON standard.

However, the fact that a continuous mode TIA has an AGC time of more than several microsecsonds represents the biggest obstacle to a burst mode operation. Further, the amplifiers, such as the F0100408B having no AGC function, while not introducing an AGC time delay, has receiver sensitivity degraded by 2 to 3 dB as compared with a general continuous mode receiver.

### SUMMARY OF THE INVENTION

Accordingly, the present invention has been made to solve the above-mentioned problems occurring in the prior art and provides additional advantages, by providing a burst mode optical receiver capable of reducing the deterioration of receiver sensitivity in an E-PON system.

One aspect of the present invention is to provide a method in which an AGC time is reduced or eliminated in a continuous mode TIA while minimizing deterioration of receiver sensitivity, so that an optical receiver operates in a burst mode.

In one embodiment, there is provided a method for receiving burst mode signals in an Ethernet-based passive optical network including a TransImpedance Amplifier (TIA), the method including the steps of detecting an amount of light, converting the amount of light into electric current, outputting the electric current, converting the electric current output into a voltage for output in a continuous mode operation, and applying external signals for fixing a gain of the TIA in a burst mode operation.

Another aspect of the present invention is to provide an optical receiver for receiving burst mode signals in an Ethernet-based passive optical network, the optical receiver including a photo diode for detecting an amount of light, converting the amount of light into electric current signals, and outputting the electric current signals, a TransImpedance Amplifier (TIA) for converting the electric current signals output from the photo diode into voltage signals, automatically controlling a gain of the voltage signals in a continuous mode operation, and outputting amplified voltage signals; and an Automatic Gain Control (AGC) control power supply unit for generating signals for fixing a gain of the TIA to a predetermined constant in a burst mode operation, and applying the generated signals to the TIA.

### BRIEF DESCRIPTION OF THE DRAWINGS

The above features and advantages of the present invention will be more apparent from the following detailed description taken in conjunction with the accompanying drawings, in which:

FIG. 1 is a diagram illustrating the general construction of a PON;

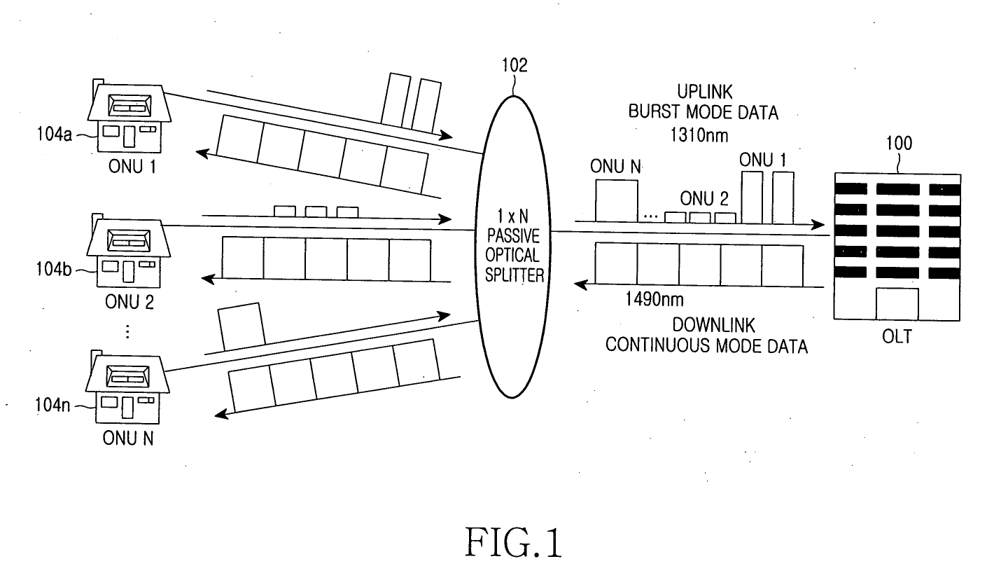

FIG. 2 is a graph illustrating a BER based on the amplitude of adjacent ONU signals received in a burst mode according to the prior art;

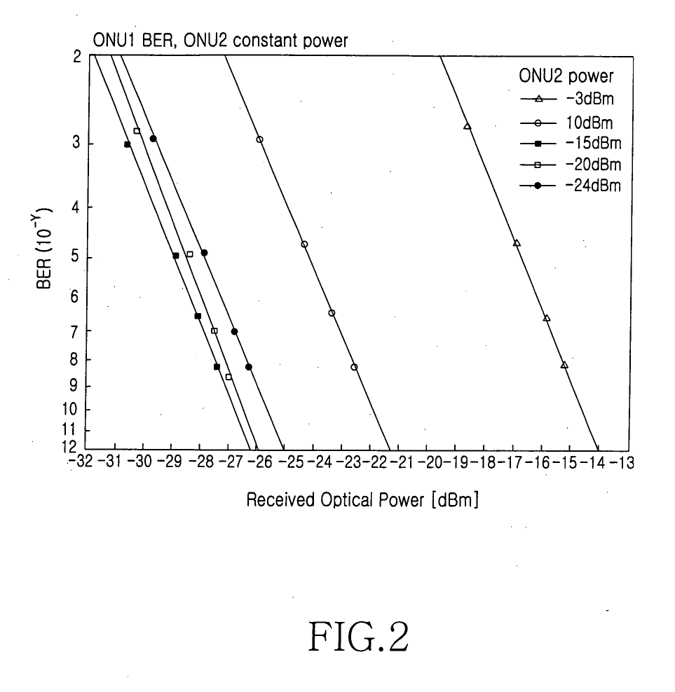

FIG. 3 is a block diagram illustrating the construction of a burst mode optical receiver according to a first embodiment of the present invention;

FIG. 4 is a graph illustrating a measurement result of a BER based on adjacent Optical Network Units (ONUs), which are received at an OLT, according to a first embodiment of the present invention;

FIG. 5 is a block diagram illustrating the construction of a burst mode optical receiver according to a second embodiment of the present invention;

FIG. 6 is a diagram illustrating general factors in determining settling time in an optical receiver;

FIGS. 7A and 7B illustrate an AC coupling time based on an RC charging time and a cut-off frequency of an AC coupler, respectively; and

FIG. 8 is a graph illustrating receiver sensitivity based on the amplitude of adjacent signals in a burst mode operation according to the second embodiment of the present invention.

### DETAILED DESCRIPTION OF THE EMBODIMENT

Embodiments of the present invention will be described in detail herein below with reference to the accompanying drawings. For the purposes of clarity and simplicity, a detailed description of known functions and configurations incorporated herein will be omitted as it may obscure the subject matter of the present invention.

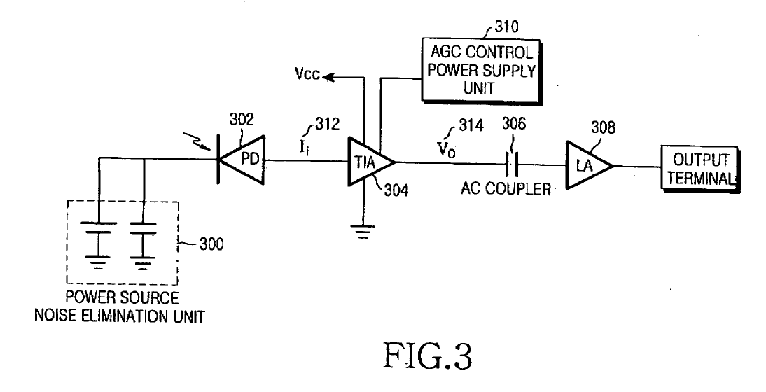

FIG. 3 is a block diagram illustrating the construction of a burst mode optical receiver according to a first embodiment of the present invention.

In this first embodiment, the burst mode optical receiver includes a power source noise elimination unit 300, a Photo Diode (PD) 302 for changing an amount of light into an amount of electric current, a TransImpedance Amplifier (TIA) 304 for receiving electric current (Iᵢ) 312 from the PD 302 and converting the received electric current into voltage (Vₒ) 314, an AC coupler 306, and a Limiting Amplifier (LA) 308 for amplifying received signals. The TIA 304 is an amplifier used in a continuous mode, which can provide an Automatic Gain Control (AGC) function when an external AGC voltage is applied by AGC power supply unit 310. In the first embodiment of the present invention, an M02016 device manufactured by Mindspeed, Inc. is used as the TIA 304.

In this first embodiment of the present invention, the TIA 304 is used in order to control the AGC function. The TIA 304 fixes a transimpedance gain to a desired value by means of external voltage V_{agc} applied from AGC control power supply unit 310. Accordingly, the AGC function of the TIA 304 is limited and the gain of the TIA 304 is fixed to a predetermined constant. In this first embodiment of the present invention, the V_{agc} of the TIA 304 is fixed at 1.2 V. Because the gain does not change according to input, the time delay introduced by the AGC is substantially a zero value. Therefore, receiver sensitivity in a continuous mode is maintained and the operation can be performed in a burst mode. As a result, it is possible to obtain an operational range of 24.8 dB, wherein the operational range represents a difference [−2.2 dBm−(−27 dBm)=24.8 dB] between the amplitude of adjacent ONU signals and reception sensitivity.

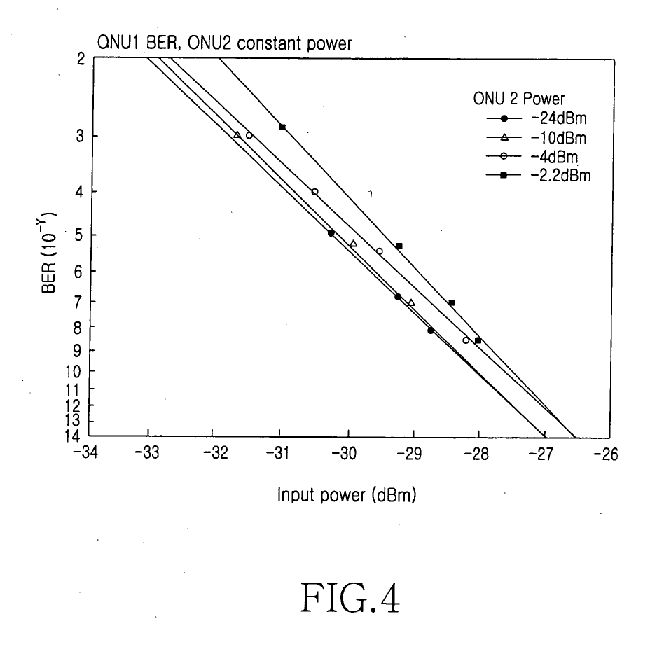

FIG. 4 is a graph illustrating a measurement result of a Bit Error Rate (BER) based on adjacent Optical Network Units (ONUs), according to the first embodiment of the present invention. The horizontal axis represents the amount of light input to the PD 302 and the vertical axis represents a BER. As illustrated in FIG. 4, it can be understood that the change in the BER is very small compared to the amplitude of adjacent ONU signals.

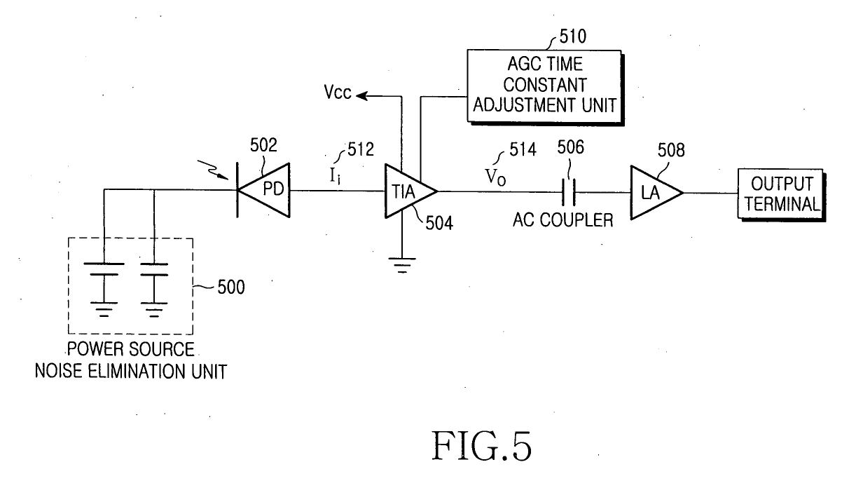

FIG. 5 is a block diagram illustrating the construction of a burst mode optical receiver according to a second embodiment of the present invention.

In this second embodiment, the burst mode optical receiver includes a power source noise elimination unit 500, a PD 502 for changing an amount of light into an amount of electric current, a TIA 504 for receiving electric current (Iᵢ) 512 from the PD 502 and converting the received electric current into voltage (Vₒ) 514, an AC coupler 506, and an LA 508 for amplifying received signals. The TIA 504 is an amplifier used in a continuous mode, which can adjust an AGC time by using an AGC time constant adjustment unit 510. In the second embodiment of the present invention, an ATA12001 device manufactured by Anadigics, Inc., is used as the TIA 504. However, it is also possible to use other devices in addition to the ATA12001 device as described in the present specification.

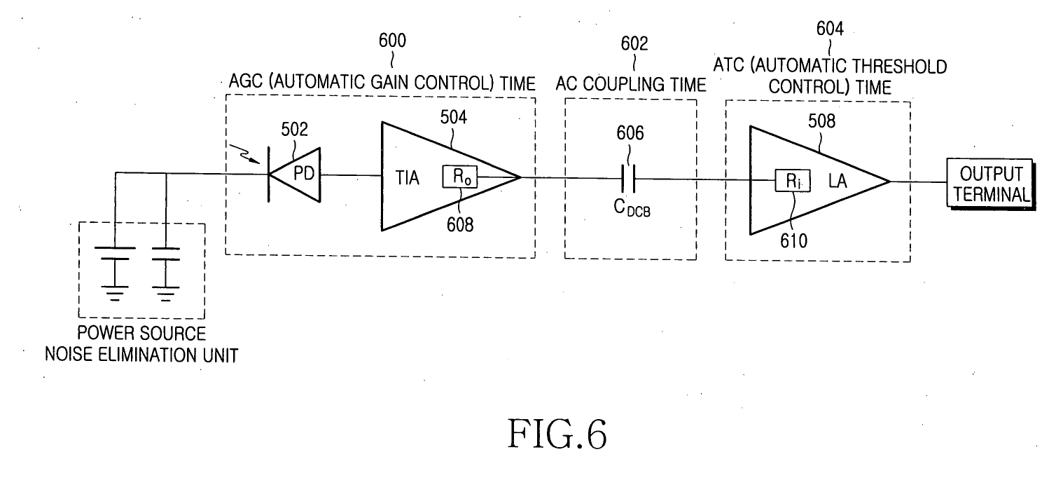

Before describing the second embodiment of the present invention, a reason for a settling time delay in the optical receiver will be described with reference to FIG. 6.

As illustrated in FIG. 6, a settling time of a general burst mode receiver is determined based on an AGC time 600 of the PD 502 and the TIA 504, an RC charging time 602 of the AC coupler 506 between the TIA 504 and the LA 508, and an Auto Threshold Control (ATC) time 604 of the LA 508.

The AGC function of the TIA 504 adjusts the gain value of the TIA 504 according to the amplitude of input signals. That is, when the amplitude of input signals is small, the AGC function causes the TIA 504 to have a large gain. However, when the amplitude of input signals is large, the AGC function lowers the gain of the TIA 504. Accordingly, the AGC function widens the operational range of input signals. Further, most continuous mode TIAs have the AGC function. In a case, in which a gain conversion time increases, when signals of a small amplitude are input after signals of a large amplitude, the gain does not increase. Therefore, an error may occur. The AC coupling time 602 is determined by a DC blocking condenser 606 (FIG. 6) between the TIA 504 and the LA 508, and output resistor (Rₒ) 608 of the TIA 504 and input resistor (Rᵢ) 610 of the LA 508.

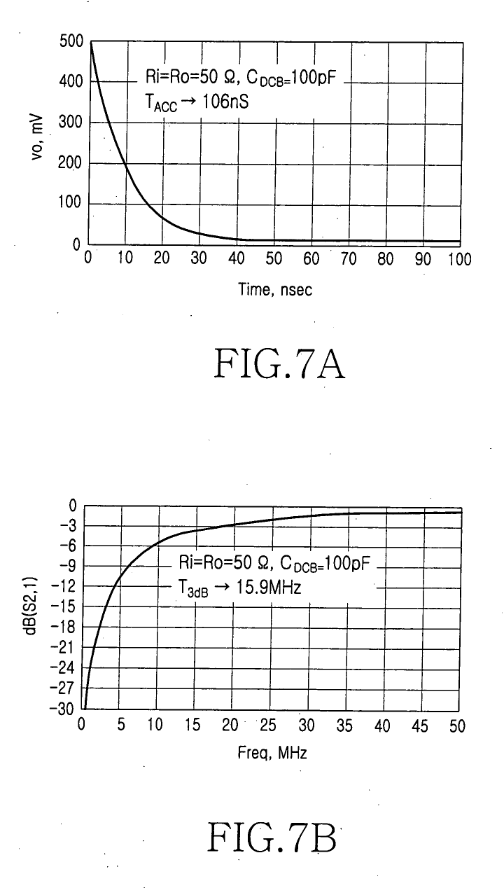

Because an E-PON system uses a coding scheme of 8 bits or 10 bits, as described previously, and a measurement scheme of a 27-1 Pseudo Random Binary Sequence (PRBS), the low frequency cut-off frequency increases. When a blocking condenser of 100 pF (picoFarads) is used for condenser 606, receiver sensitivity deterioration of only 0.8 dB as compared with a case in which a blocking condenser of 100 nF (nanoFarads) is used. Accordingly, when a blocking condenser of several hundreds of pF is used, a burst mode operation can be performed even though an AC coupler is used. An AC coupling time of 106 ns (nanoseconds) is necessary for preventing strong signals of −1 dBm, in a case in which the condenser, the output resistor Rₒ 608 of the TIA 504 and the input resistor Rᵢ 610 of the LA 508 have values of 100 pF, 50 ohms (Ω)and 50 ohms (Ω) respectively, from affecting signals of −27 dBm. This is illustrated in FIG. 7A.

FIG. 7A is a graph illustrating the AC coupling time based on the RC charging time. According to a general standard of an optical receiver, received signals have the largest intensity of −1 dBm and the smallest intensity of −27 dBm. In FIG. 7A, the vertical axis represents voltage input to the LA 508, and the horizontal axis shows that a point in time when signals at the largest voltage 500 mV are reduced by 26 dBm, i.e. are reduced in magnitude to 1/40000 of the signals, is 106 ns. Accordingly, in the settling time for the burst mode operation of the optical receiver, the AC coupling time does not affect the signals of −27 dBm.

FIG. 7B is a graph illustrating the cut-off frequency of the AC coupler 506. The vertical axis represents a gain and the horizontal axis represents the passing frequency of the AC coupler 506. As illustrated in FIG. 7B, it can be understood that the AC coupler 506 passes signals of more than 15.9 MHz with almost no attenuation.

As described in FIGS. 7A and 7B, because the AC coupling time of the settling time in the burst mode operation does not greatly affect the signals of −27 dBm, the present invention adjusts only the AGC time which is the largest time in determining the delay.

The AGC time constant is determined by a resistor Rᵢₙ (not shown) and a condenser Cᵢₙ in the TIA 504, and an external condenser Cₑ in the AGC time constant adjustment unit 510, which may be expressed as:
AGC time constant=Rᵢₙ×(Cᵢₙ+Cₑ) [1]

It is recommended that the external condenser Cₑ having large capacity in the range of several hundred pF to several tens of nF (nanofarads) is connected to the continuous mode TIA. In order to operate the TIA in the burst mode, either the external condenser Ce is turned off or the external condenser Cₑ having capacity of less than several tens of pF is used. An actually manufactured burst receiver has an operation range of more than 23.4 dB.

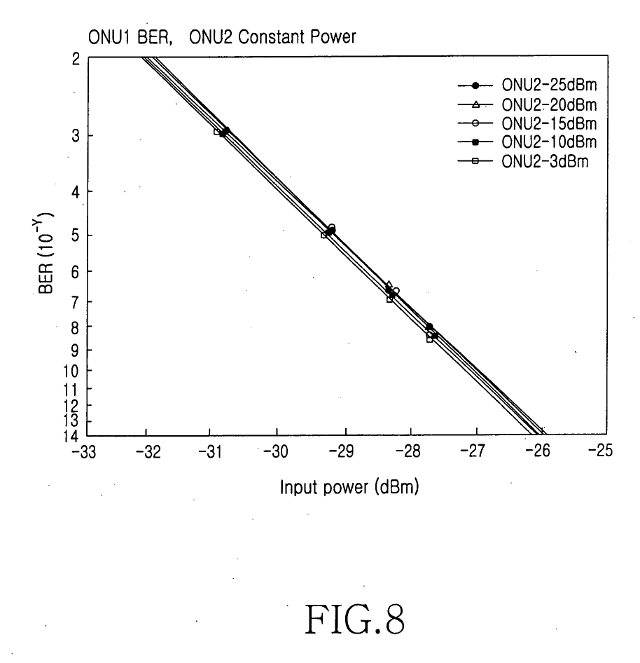

FIG. 8 is a graph illustrating receiver sensitivity based on the amplitude of adjacent signals in the burst mode operation according to the second embodiment of the present invention.

FIG. 8 shows a measurement result of a BER based on adjacent ONUs, which is received by OLT 100. The horizontal axis represents an amount of light input to the PD 502 and the vertical axis represents a BER. As illustrated in FIG. 8, it can be understood that the BER between the adjacent ONUs is substantially constant.

While the present invention has been shown and described with reference to certain preferred embodiments thereof, it will be understood by those skilled in the art that various changes in form and details may be made therein without departing from the spirit and scope of the invention as defined by the appended claims.

What is claimed is:

1. An optical receiver for receiving burst mode signals in an Ethernet-based passive optical network (E-PON), the optical receiver comprising:
a photo diode for detecting an amount of light, converting the amount of light into electric current signals, and outputting the electric current signals;
a TransImpedance Amplifier (TIA), in communication with the photo diode, for converting the electric current signals output from the photo diode into voltage signals for output, automatically controlling a gain of the voltage signals in a continuous mode operation, and outputting amplified voltage signals; and
an Automatic Gain Control (AGC) power supply unit for generating signals for fixing a gain of the TIA to a predetermined constant in a burst mode operation, and applying the signals to the TIA.

2. The optical receiver as claimed in claim 1, wherein the TIA receives external signals for fixing an amplification gain to a constant.

3. A method for receiving burst mode signals in an Ethernet-based passive optical network (E-PON) including a TransImpedance Amplifier (TIA), the method comprising the steps of:
detecting an amount of light;
converting the amount of light into electric current;
outputting the electric current to the TIA;
converting the electric current output into a voltage for output in a continuous mode operation; and
applying external signals for fixing a gain of the TIA in a burst mode operation.

4. An apparatus for receiving burst mode signals in an Ethernet-based passive optical network (E-PON), the apparatus comprising:
a photo diode for detecting an amount of light, converting the amount of light into electric current signals, and outputting the electric current signals;
a TransImpedance Amplifier (TIA), electrically connected to the photo diode, for converting the electric current signals output from the photo diode into voltage signals, automatically controlling a gain of the voltage signals in a continuous mode operation, and outputting amplified voltage signals; and
an AGC time constant adjustment unit connected to change a value of an external condenser of the TIA in order to change an automatic gain time constant value, which is determined by an internal resistor and an internal condenser of the TIA and the external condenser, to a value within a predetermined time.

5. The apparatus as claimed in claim 4, wherein the AGC time constant adjustment unit includes a condenser in order to adjust the automatic gain time constant value of the TIA.

6. A method for receiving burst mode signals in an Ethernet-based passive optical network (E-PON) including a TransImpedance Amplifier (TIA), the method comprising the steps of:
detecting amount of light;
converting the amount of light into electric current signals;
outputting the electric current signals;
converting the electric current signals into voltage signals for output; and
adjusting an automatic gain time constant value by using an external condenser in order to reduce an Automatic Gain Control (AGC) time of the E-PON in a burst mode operation.

7. A method for processing burst mode signals in Passive Optical Network, comprising the steps of:
receiving an amount of light by a photo diode, the photo diode converting the received amount of light into electrical current signals;
providing the electrical current signals to an amplifier for converting the provided electrical current signals to a voltage signal; and
providing an external signal to the amplifier to adjust a parameter in the amplifier for altering the conversion of the current signals to the voltage signal.

8. The method as recited in claim 7, wherein the external signal adjusts a gain time constant value.

9. The method as recited in claim 7, wherein the external signal adjusts the amplifier gain to a predetermined value.

10. The method as recited in claim 7 wherein the amplifier is a TransImpedance Amplifier.

11. An apparatus for processing burst mode signals in a Passive Optical Network, the apparatus comprising:
a photodiode converting a received amount of light into an electrical current;
an amplifier connected to the photodiode converting the electrical current provided by the photodiode into a voltage; and
an amplifier adjustment unit generating a signal for adjusting the parameters of the amplifier for controlling a level of the voltage.

12. The apparatus as recited in claim 11, wherein the amplifier adjustment unit generated signal adjusts the amplifier gain to a predetermined constant value.

13. The apparatus as recited in claim 11, wherein the amplifier adjustment unit generated signal adjust a gain time constant.

14. The apparatus as recited in claim 11, wherein the amplifier is a TransImpedance Amplifier.

15. The apparatus as recited in claim 11, further comprising:
a limiting amplifier A/C coupled to the amplifier.
